(19) United States
(12) Patent Application Publication
(10) Pub. No.: US 2012/0303728 A1
(43) Pub. Date: Nov. 29, 2012

(54) REPORT GENERATION SYSTEM WITH RELIABLE TRANSFER

(76) Inventors: Andrew P. Fitzsimmons, Punta Gorda, FL (US); James L. Kreider, Fort Myers, FL (US)

(21) Appl. No.: 13/482,168

(22) Filed: May 29, 2012

Related U.S. Application Data
(60) Provisional application No. 61/490,140, filed on May 26, 2011.

(51) Int. Cl. G06F 15/16

(52) U.S. Cl. 709/206

(57) ABSTRACT

A data collection and report generation system that included mobile devices in the field that are used to collect data, such as during a property inspection. The data is uploaded to a server system to analyze and generate reports and other documents. The documents are then delivered to desired recipients. Correctness of the data is an essential need and, the transfer of the data from the mobile device to the server is accomplished by first compressing the data and then attaching the data to an email message. An email server operates to automatically decompress the data, pass the data to the server and initiate the process of report generation and delivery automatically without any further user interaction either by the user device or a server operator.

### CROSS-REFERENCE TO RELATED APPLICATIONS

This patent application is a non-provisional application filed with the United States Patent and Trademark Office pursuant to Title 35, United States Code §100 et seq. and 37 C.F.R. Section 1.53(b) and, claiming priority under Title 35, United States Code §119(e) to U.S. Provisional Application for Patent having been assigned the Ser. No. of 61/490,140 and filed on May 26, 2011, which application is herein incorporated by reference.

### BACKGROUND

This disclosure relates generally to inspection and report generation, such as reports required for home inspections, appraisals, insurance and so forth, wherein information that is collected in the field is then used to create a report summarizing certain findings, and more particularly, this disclosure presents a method and system to increase the efficiency with which such reports are created and for reliably transferring data between a mobile data collection device to a remote server for report generation and access.

The rise of on-line services has changed the way the world does business. Even in industries that are not directly related to on-line technology, the deployment of various on-line activities and services has most likely had an effect on the industry in one way or another. One particular industry that has been strongly affected by on-line services is the real-estate industry. Buyers have migrated from window shopping from their automobiles to, cruising through listings and myriads of information readily available to the consumer on-line. The abundance and availability of such information being delivered or obtained directly by the consumer has had a tendency to demystify the real-estate agent who, prior to such technology, was heavily relied upon for obtaining any information about a potential property that was being considered. It is only natural that as consumers perceive that a realtor brings less value to the table, that the willingness of a consumer to pay the standard percentage rates declines. In a market in which real-estate values are depressed, coupled with a tendency to reduce realtor fees, the real-estate industry is impacted by a significant squeeze.

As in most industries, when one sector of the industry is impacted, either positively or negatively, other aspects or services ancillary to the industry are also impacted. One of the ancillary services that are impacted with regards to the real-estate industry are property inspectors and appraisers. With the depressed realty market, lending institutes, in an effort to mitigate their risks, are applying significant pressure on inspectors and appraisers to ensure that value is properly assessed and problems are clearly identified. This pressure results in requiring more time on site, more thorough inspections, and thus, more cost to the inspector and/or appraiser.

The old adage that was first promulgated by Benjamin Franklin states that “time is money”. For an inspector or appraiser (collectively referred to as an inspector throughout this description unless otherwise delineated), the more time that is spent on-site performing the inspection, the less money and/or value that is obtained for the work.

For a typical inspector, time must be scheduled at the inspection site during which the inspector can gain access to the entirety of the property. After spending a number of hours, probing, crawling, climbing, testing, drawing, photographing, making notes, etc., the inspectors work is really just beginning. The inspector must then take the information that has been collected during the inspection and transform this into a final report. To accomplish this task, the inspectors spend a significant amount of time in front of a computer to organize the information into a complete inspection report. Depending on the work flow of the inspector, this can result in a consumer waiting a considerable amount of time before the report can be received. Furthermore, the traditional form of inspecting and preparing reports is prone to errors due to data entry problems, misinterpretation of handwritten notes, memory loss due to the lag time between inspections and report generations, confusion that arises due to conducting inspections of multiple properties between report writing sessions, etc.

What is needed in the art is a solution that improves the reliability of inspection reports by allowing data to be entered as it is collected on site. Further, what is needed in the art is a solution to reduce the amount of time required for converting or assimilating the data that was collected during an inspection into a report. Yet further, what is needed in the art is a solution that improves the accuracy of inspection data, reduces the time required for conducting an inspection and gives the ability to access and share inspection information in a readily available manner.

As cellular technology has migrated from analog mobile phone systems (AMPS) in the early 1980's to today's digital networks, a significant improvement in the transfer of data over the cellular network infrastructure has also been realized. However, in a wireless network, reliable and error free data transfer remains as a technical hurdle. Much of the problems with reliable data transfer in a wireless network is due to the fact that the data transmission devices are mobile, and the transmission quality is effected by changing atmospheric conditions and geographic or other obstructions in signal transmission. These and other issues play a significant part in the generation of multi-path signal interference, electro-magnetic radiation interference, and simply lost data. In the voice arena, minor losses of data can be easily ignored. However, in a data scenario, accuracy and completeness of data transfer remains an important element. With the advent of 3G and GPRS data capabilities, significant bandwidth has been introduced for data transfer but, the loss and corruption associated with data transfer continues to be a problem. In fact, as larger amounts of data are transferred, the loss and corruption of this data is even amplified. For the various embodiments of the inspection and report generator to which this disclosure is directed, lost data could be detrimental to the accuracy and reliability of the reports.

Furthermore, with the current state of technology in which mobile devices are jam-packed with features and functions, there is oftentimes competing interest in the performance aspects of the product. For instance, one performance aspect is the battery life of the mobile device. Consumers want their mobile devices to remain charged for prolonged periods of time. In an effort to increase battery life, cellular protocols attempt to reduce the transmission power of a mobile device whenever possible. Thus, the mobile system and/or the mobile devices monitor the signal quality and attempt to push the transmission power to the lowest level possible while still maintaining connectivity. While this technique may be quite sufficient for a typical voice call in which loss of data may go unnoticed, in the data realm this can be catastrophic.

The present disclosure presents an environment in which reliable data transfer of large amounts of data is necessitated. Data is collected remotely and then transferred to a remote server at least partially over a wireless network. Such transfers, as previously presented are exceedingly prone to errors, data loss and data corruption. Thus, there is a need in the art for a solution to reliably transfer inspection data from a remote data collection device to a server, and to transfer reports generated by the server to other devices, such as mobile devices.

These needs in the art, as well as other needs are met by the various embodiments presented within this description.

### BRIEF SUMMARY

The present disclosure presents various embodiments of a system, method and device, as well as various features, advantages and aspects thereof, that provide an improved ability to perform property inspections, as well as any of a variety of other inspections or activities that require the collection of data in the field, facilitate the conversion of the data into electronically available reports, and make the reports available in an on-line environment.

For example, various embodiments, referred generically to as report generators, enable the transformation of information collected at a remote location into an electronic report through the use of mobile electronic devices, email, servers and network technology.

The above-identified needs in the art, as well as other needs are met by a report generator that may operate as, or within, or in conjunction with a mobile electronic device, such as an ANDROID, IPHONE, IPAD, smart phone, tablet or any other mobile device having connectivity to the internet or other network (collectively referred to herein as a “user device”). The user device may be a custom, OEM, dedicated device designed specifically to implement an embodiment of the report generator or, may be a generic user device that can be modified to operate as a report generator by adding or modifying the hardware or software of the user device. For instance, the user device may accept and execute a software application, module, plug-in or the like, as well as received hardware changes or interface to hardware and/or software components to implement the report generator.

In operation, an inspector may use the report generator to collect information such as notes, photographs and so forth in real-time or in close time-wise proximity to when the information is collected, although the user can certainly opt to enter the information at a later date, time and place. Once the information has been received by the user device, the information can be saved within the user device and further sent to a central server. The information can be transferred to the central server in a variety of manners and one non-limiting example is by the use of email available such as by using a POP3 server.

The various embodiments of the report generator may be used in any of a variety of environments, industries and fields in which inspections are conducted, such as home inspections, appraisals, insurance casualty inspections, Chinese drywall inspections, stucco inspections, and so forth.

The various embodiments, as well as features, advantages and aspects of the embodiments of the report generator will become even more readily apparent to those of ordinary skill in the relevant art upon a reading of the following detailed description in conjunction with the drawings wherein there is shown and described illustrative embodiments of the report generator.

### BRIEF DESCRIPTION OF THE SEVERAL VIEWS OF THE DRAWING

FIG. 1 is a functional block diagram of the components of an environment for hosting of one or more elements, components, modules, functions or the like, of various embodiments of the report generator.

FIG. 2A illustrates a distributed configuration embodiment of the report generator.

FIG. 2B illustrates a mobile configuration embodiment of the report generator.

FIG. 2C illustrates a server based or computer based embodiment of the report generator.

FIG. 3 is a conceptual diagram of an exemplary user interface that can be implemented in various embodiments of the report generator.

FIG. 4A, FIG. 4B and FIG. 4C collectively illustrate a flow diagram illustrating exemplary actions that can be performed by one exemplary embodiment of the report generator.

FIG. 5 is a block diagram of a technique that has been employed in the art for providing stable large data transfers from a mobile device.

FIG. 6 is a block diagram illustrating a data transfer technique that can be employed in various embodiments of the report generator system.

FIG. 7 is a data flow diagram illustrating the operations of one exemplary embodiment of the report generator.

### DETAILED DESCRIPTION

Aspects, features and advantages of several exemplary embodiments of the report generator will become better understood with regard to the following description in connection with the accompanying drawing(s). It should be apparent to those skilled in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of various embodiments as defined herein and equivalents thereto. Hence, use of absolute terms such as, for example, “will,” “will not,” “shall,” “shall not,” “must” and “must not” are not meant to limit the scope of the various embodiments as the embodiments disclosed herein are merely exemplary.

The word “exemplary” is used herein to mean “serving as an example, instance, or illustration.” Any aspect described herein as “exemplary” is not necessarily to be construed as exclusive, preferred or advantageous over other aspects. Turning now to the figures, the various embodiments, as well as features, advantages and aspects thereof will be presented.

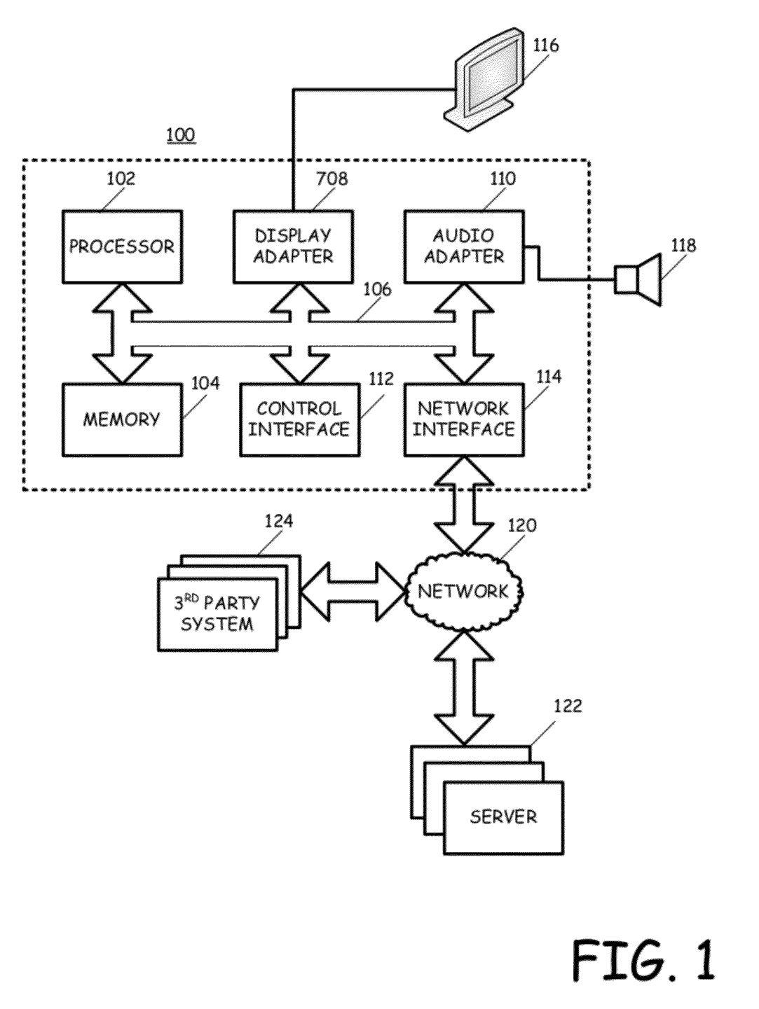

FIG. 1 is a functional block diagram of the components of an environment for hosting of one or more elements, components, modules, functions or the like, of various embodiments of the report generator. It will be appreciated that not all of the components illustrated in FIG. 1 are required in all embodiments of the report generator but, each of the components are presented and described in conjunction with FIG. 1 to provide a complete and overall understanding of the components. Further, the report generator can be embodied in a single system configured as illustrated in FIG. 1, or, can be comprised of multiple devices or systems each of which may be configured as illustrated in FIG. 1. The controller can include a general computing platform 100 illustrated as including a processor/memory device 102/104 that may be integrated with each other or, communicatively connected over a bus or similar interface 106. The processor 102 can be a variety of processor types including microprocessors, micro-controllers, programmable arrays, custom IC's etc. and may also include single or multiple processors with or without accelerators or the like. The memory element of 104 may include a variety of structures, including, but not limited to, RAM, ROM, magnetic media, optical media, bubble memory, FLASH memory, EPROM, EEPROM, etc. The processor 102, or other components in the controller, may also provide other components such as a real-time clock, analog-to-digital convertors, digital-to-analog convertors, etc. The processor 102 also interfaces to a variety of elements including a control interface 112, a display adapter 108, an audio adapter 110, and network/device interface 114. The control interface 112 can be used to provide an interface to external controls, such as sensors, actuators, drawing heads, nozzles, cartridges, pressure actuators, leading mechanism, drums, step motors, a keyboard, a mouse, a pin pad, an audio activated device, memory elements, CD drives, DVD drives, as well as a variety of the many other available input and output devices or, another computer or processing device or the like as non-limiting examples. The display adapter 108 can be used to drive a variety of visual elements or display elements 116, such as display devices including an LED display, LCD display, one or more LEDs or other display devices. The audio adapter 110 interfaces to and drives another element 118, such as a speaker or speaker system, buzzer, bell, etc. The network/interface 114 may interface to a network 120 which may be any type of network including, but not limited to, the Internet, a global network, a wide area network, a local area network, a wired network, a wireless network or any other network type including hybrids of various types of networks. Through the network 120, or even directly, the controller 100 can interface to other devices or computing platforms such as one or more servers 122 and/or third party systems 124 including computers, mobile devices or the like. A battery or power source provides power for the controller 100.

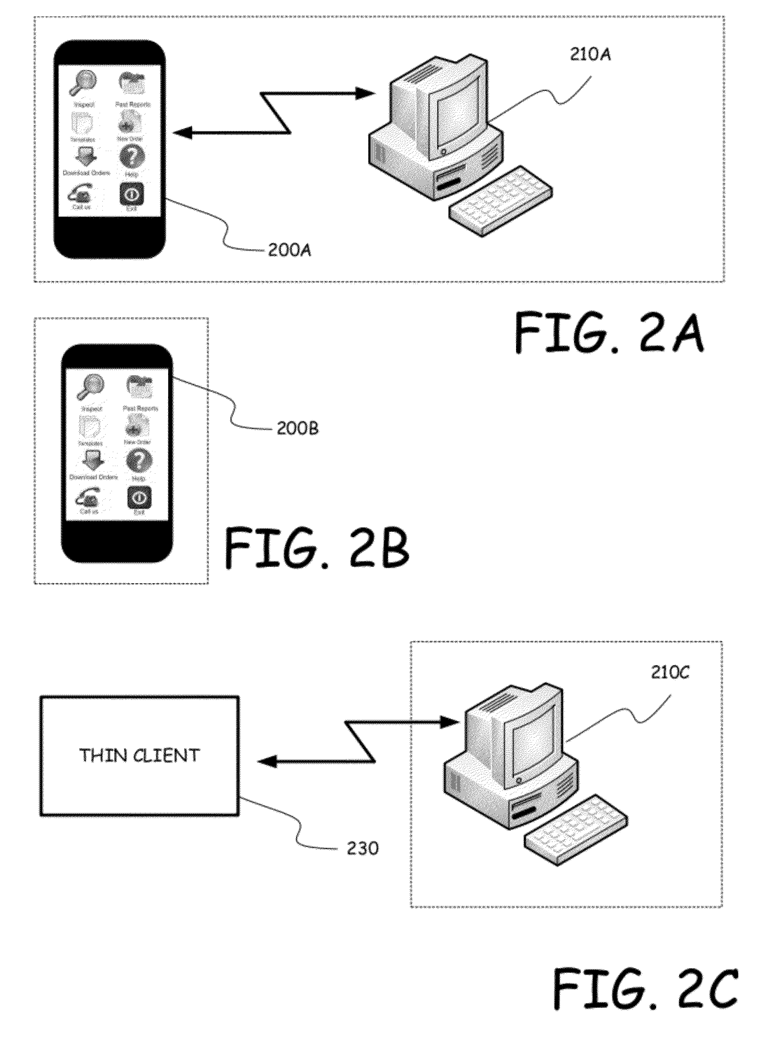

FIGS. 2A-2C are system block diagrams illustrating three non-limiting examples of potential system configurations for various embodiments of the report generator. FIG. 2A illustrates a distributed configuration embodiment of the report generator. FIG. 2B illustrates a mobile configuration embodiment of the report generator. FIG. 2C illustrates a server based embodiment of the report generator. In the embodiment illustrated in FIG. 2A, the user device 200A interfaces with a server 210A over a communications interface 220A. In such an embodiment functionality of the report generator can be distributed between the user device 200A and the server 210A in various configurations and at differing levels of detail. In the embodiment illustrated in FIG. 2B, the functionality of the report generator is entirely located within the user device 200B. In such an embodiment, the user device 200B can perform all the necessary functions required for the particular embodiment of the report generator without having to use external resources; however, such an embodiment does not imply that the user device 200B cannot interface with other devices such as a database for storing report information, obtaining other pre-prepared reports, etc. In the embodiment illustrated in FIG. 200C, the functionality of the report generator is entirly located within a server 210C. In such an embodiment, the server 210C can perform all the necessary functions required for the particular embodiment of the report generator without having to use external resources; however, such an embodiment does not imply that the server 210C cannot interface with other devices, such as a thin client 230 to serve as a local or remote user interface to the report generator, or other devices as well.

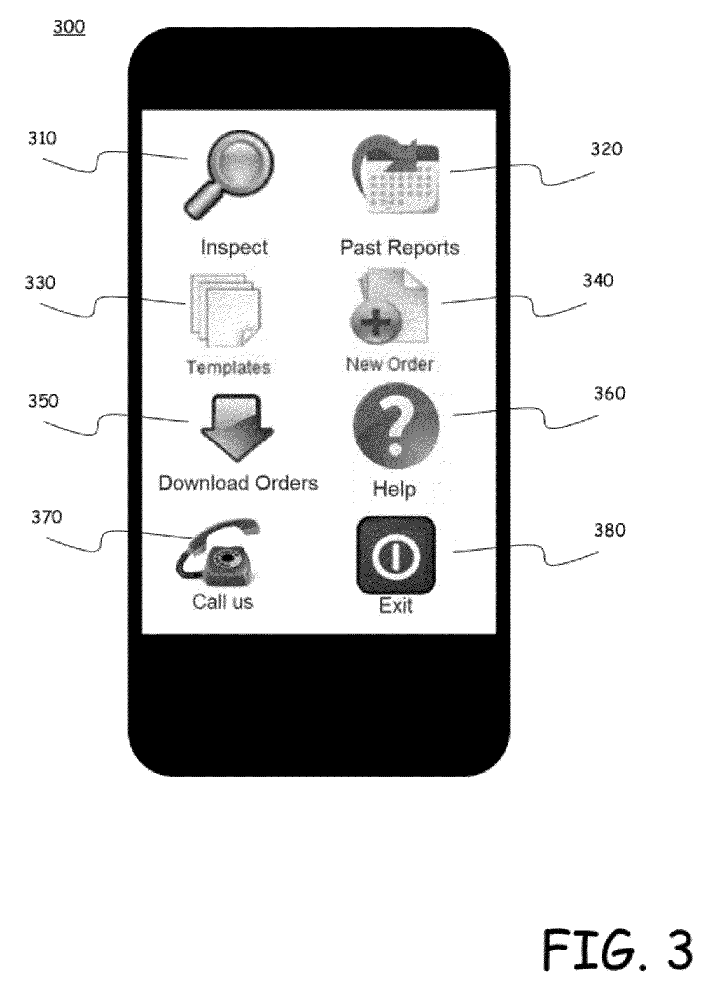

FIG. 3 is a conceptual diagram of an exemplary user interface that can be implemented in various embodiments of the report generator. The user device 300 can be any of a variety of mobile or stationary electronic devices, such as a smart phone, electronic pad, laptop computer, stationary computer, PDA, etc. In general, the user device 300 will include communications technology to enable the user device 300 to communicate over a communications channel, such as a network, wireless network, cellular network, BLUETOOTH, or the like but, it will be appreciated that in other embodiments, the user device 300 may be required to tether to a communications device or, directly to a server as necessary.

Typically, the user device 300 will include one or more hard controls built into the device (not illustrated) for selecting various elements and performing actuations but, in some embodiments the user device housing the report generator may be completely controlled by the use of soft keys displayed on a touch sensitive screen. In the illustrated embodiment, eight soft keys are displayed:

An Inspect soft key 310;

A Past Reports soft key 320;

A Templates soft key 330;

A New Order soft key 340;

A Download Orders soft key 350;

A Help soft key 360;

A Call Us soft key 370; and

An Exit soft key 380.

The user device 300 may be a dedicated device with the functionality of the report generator embedded into the user device or, the functionality may be subsequently installed into the user device 300. Installing the functionality of the report generator may be accomplished by downloading an application or connecting the user device 300 to another computing platform for installing the functionality. It will also be appreciated that the user device 300 may simply serve as an interface to another device that houses and executes the report generator, such as an application in the user device that interfaces to the report generator and simply serves as a dummy terminal or thin client for the report generator. The interface to the report generator in such embodiments may be any of a variety of wired or wireless connections. Throughout this description, the embodiment illustrated in FIG. 2A will be presented in the most detail for illustrative purposes only. The embodiment illustrated in FIG. 2A is that in which the user device 300 downloads an application to be executed therein and for interfacing with a remote server for uploading data and generating reports. However, it will be appreciated that the functionality of the various embodiments can easily be incorporated into the other illustrated embodiments as well as other non-illustrated embodiments.

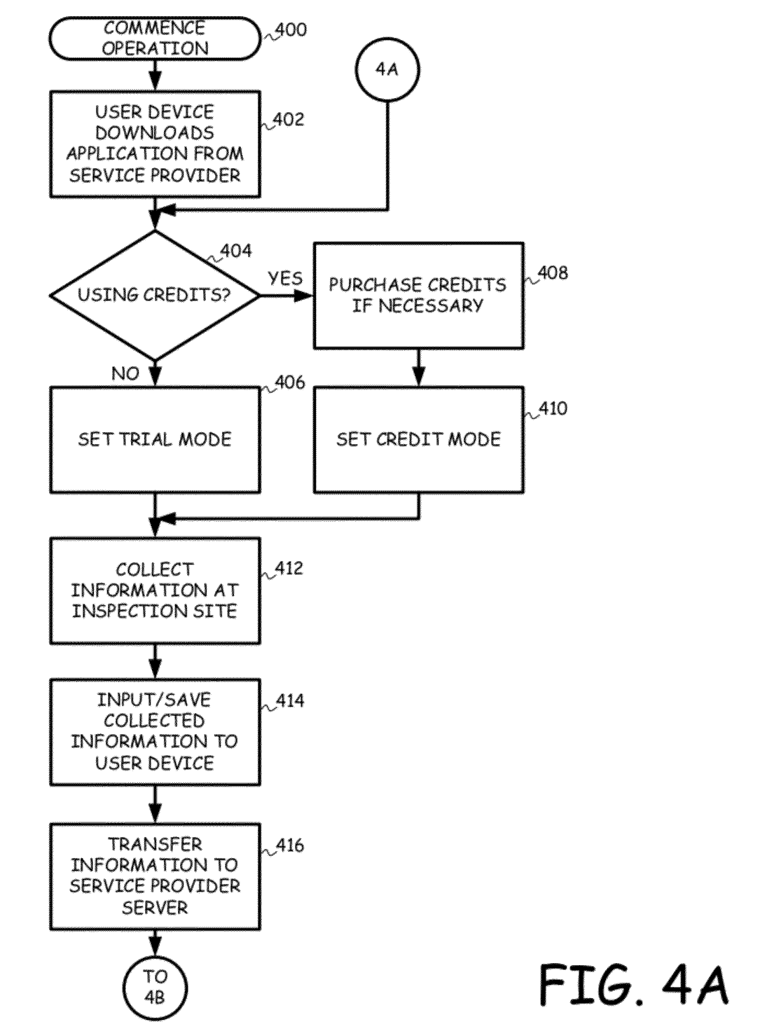

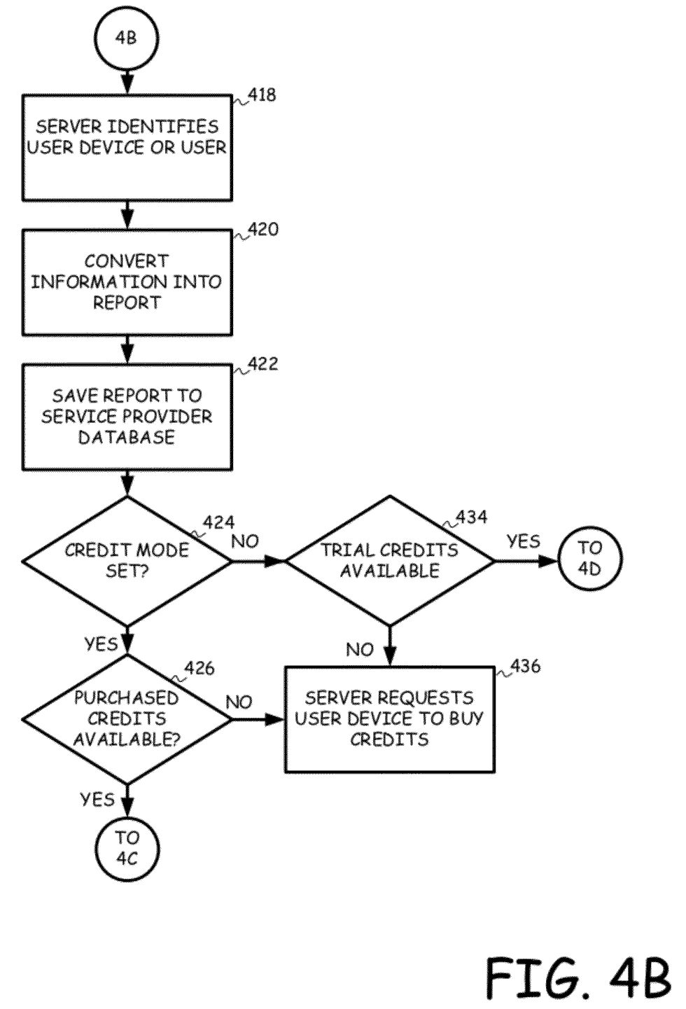

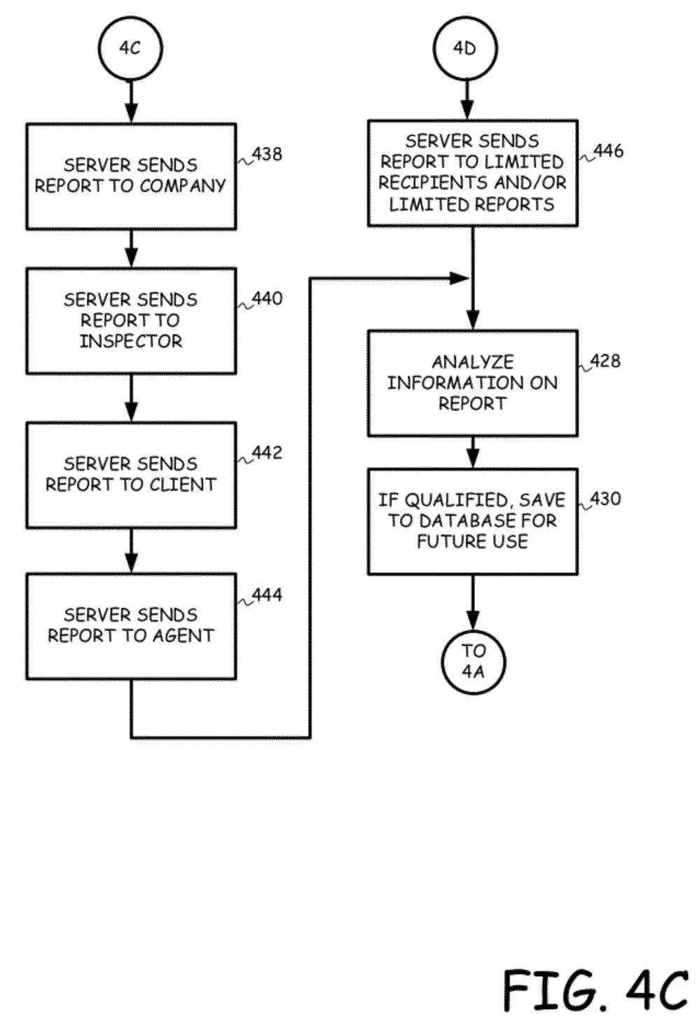

FIG. 4A is a flow diagram illustrating exemplary actions that can be performed by one exemplary embodiment of the report generator. The actions will be described as being relevant to the embodiment illustrated in FIG. 2A. In the embodiment illustrated in FIG. 2A, the user device is described as including some functionality. For instance, the user device 300 can render a user interface to allow a user to actuate various functions of the report generator, such as entering data during an inspection, initiating an inspection, obtaining previously stored reports, etc. Some actuations of the user device 300 result in the user device communicating with server 310A. For instance, once an inspection is completed, the user can cause the data to be transferred to the server 310A for analysis, storage and report generation.

In operation, a service provider may own, maintain and/or operate the server and then charge a fee for the usage of the system. The user devices can be distributed to customers of the service provider or, generic devices can download the necessary application from the server or another source.

For the process illustrated in FIG. 4A, initially the user device 300 is turned on or activated 400 and, if the user device 300 has not already been loaded with the report generator application, the user/inspector can invoke the download of the report generator application from a service provider 402 or other third party, such as an on-line applications store. In addition, in some embodiments the user can then create an account with the service provider over the internet by providing the service provider with personal information, such as name, address, email, username, password and so forth. Once the application is downloaded and activated, the user can select any of the available functions, such as the non-limiting example of exemplary functions presented in FIG. 3.

In an exemplary embodiment of the report generator, the use of the report generator can be provided on a fee basis. In other embodiments a straight up license can be purchased or, the application can be made available for free and include pushed advertising along with the provision of the service. For purposes of illustration, an embodiment in which the user is charged on a use basis is presented. One method to implement a pay-as-you-go use of the report generator is to allow the user of the system, such as an inspector, to purchase credits that are debited against as the user employs the use of the report generator. In addition, as a bait and hook, or simply for promotional, training or other purposes, the credit system allows a service provide to award free credits or, to allow a user a certain amount of usages as a trial period.

Thus, once the system is operating (i.e., the report generator application is executing on the user device 300), the system can check to see if the user has any credits or prompt the user to indicate if credits are to be used for operating the system 404. The user may choose to use the software for trial reports, for training, for evaluating for potential purchase etc. For instance, the user may have just downloaded the application and wants to use it for an inspection to see if it would help the user perform his or her tasks. During the trial period, several configurations could be offered. For instance, the user may be able to only access a limited amount of the functionality of the report generator. In an alternate embodiment, the user may be given full access to all aspects and functions of the report generator but, only have the ability to print limited reports or portions of reports. In yet another embodiment, full functionality and reporting may be available but, the reports may contain a watermark or other insignia to illustrate that the report was generated under trial use and typically, the report may be configured in such a way to render it undeliverable to the end customer. As a non-limiting example, each page of the report may contain the watermark or insignia “TRIAL REPORT” and thus, unfit for distribution to clients. In some embodiments, the inspector is given a limited amount of trial credits with which to purchase sample reports or actuate certain services or, the user can purchases credits from the service provider 408.

The credit query can be done upon invoking the application or, upon any actuation of a soft key that would invoke one of the features or functions of the report generator. If the user is using credits for the present operation 404, then the user is able to purchase credits if necessary 408 and in essence, the system is set into credit mode. The system is being described as being set to credit mode only for purposes of illustration. In actuality, the system may or may not actually perform a function that physically or logically activates a mode. For instance, in some embodiments, activating the credit mode may simply automatically deduct the appropriate number of credits from the user's balance and then proceed without any further knowledge of the credit mode being active.

If the user is not using purchased credits to access the report generator 404, then the process sets the trial mode to be active 406.

Once the mode of use of the user device for the report generator is resolved, the user can begin using the user device in the performance of an inspection. For example, if the system is implemented for inspection reporting, the inspector collects information at a remote location. The home inspector may conduct a home inspection in which photos are taken using the mobile electronic device or some other device that can transfer the photographs to the user device, such as a BLUETOOTH interface, a memory card, etc. In addition, notes are taken regarding the inspection and entered into the mobile electronic device via a key board or through voice recognition software as non-limiting examples 412. It should be appreciated that in some embodiments, the functionality of the user device is fully available to the user regardless of whether the user device is in trial mode or credit mode. In such an embodiment, it is not until data is uploaded to the server that the restrictions associated with trial mode are realized. In other embodiments, setting the user device in trial mode may operate to limit some of the data entry functionality of the user device.

The data/information collected is input into the user device in real-time as the inspection is being conducted or, upon the conclusion of the inspections or portions of the inspection. The data is then saved within the user device 414. The data/information is saved within the user device in an electronic file, such as a compressed file using the Zip utility. Once the inspection is complete or at any time during the inspection process , the mobile device 300 can transfer the data/information to the server being hosted by the service provider 416. This transfer may be done automatically by the user device 300, such as a background process or upon the completion of a particular function. Alternatively, the transfer may be initiated by the user performing an actuation, such as actuating an upload function. In a particular embodiment, the user or inspector may electronically submit the data/information to the server of the service provider through the use of an email message to which the compressed data file can be attached. In an exemplary embodiment, this process of submitting the data to the server is all performed with a single actuation of a button or soft key

Once the transfer is complete, processing continues at point 4B in FIG. 4B.

Upon reception of the transferred data, the server of the service provider identifies the user and/or user device that initiated the transfer 418. This can be accomplished in any of a variety of fashions. As a non-limiting example, the server may identify the user by recognizing the user's email address, by parsing content embedded within the data/information, the use of Mobile IDs, etc.

Next, the server transfers the data received from the user device to a designated database that is assigned or identified from a designation with the received data file 422. The server then assembles the data into a report format, such as a PDF report file 420. The server may then conduct a check to determine if the user has any credits available for the requested, or to be requested, services 424. In one exemplary embodiment, this is done by examining the current mode of operation (i.e., credit mode may be identified in the data transferred to the server either explicitly or implicitly, such as a user identifier that can be looked up in a database to identify if the user has available purchased credits or if not, then trial credits) or a variety of other techniques may be used such as accessing a user's account to determine if any credits are available.

If the user is utilizing the system with purchased credits and, if the user has sufficient purchased credits, then processing continues at point 4C in FIG. 4C.

At point 4C in FIG. 4C, the server electronically transmits the report, such as a secure PDF document, to one or more destinations. In an exemplary embodiments, these recipient destinations may be predetermined email addresses, such as the company email address of the user or inspector 438, the inspector's email address 440, the inspector's client's email address 442 and/or a real estate agent's address 444. In addition, the received data can be transferred to other servers and made available for viewing by secured or authorized viewing devices after logging into the server.

If the server determines that the user does not have any credits (credit mode is not set) 424, then the server checks to see if the user has any trial period credits 434. If the user does not have any trial period credits, then the inspector will be required to purchase credits prior to the report being sent 436. Alternatively, a report can be generated and sent but, marked or modified in such a way to indicated that it is a trial report and not a final version. If the inspector has trial period credits, then processing continues at point 4D in FIG. 4C where the report may be sent to a limited number of recipients depending on the services available for the trial mode of operation. As a non-limiting example, in a trial period the user may only have messages sent to a few or limited number of email accounts, such as only to the company email of the user 446 and/or the amount of information provided to the user in the form of a report may be limited when accessed and/or generated using the trial credit. In yet another embodiment, a full report may be provided but rendered unfit as a final product by using a watermark or other insignia (i.e. TRIAL REPORT).

In addition, the server may operate to analyze the information that was presented or included in the report saved within the database of the service provider 428. The server can then transform this information into databases of sales leads, appraisal comparisons, building defects, etc., as non-limiting examples 430. For instance, if a home inspection report details a plumbing problem with a house, then the sales lead can be used to gain business for a plumbing company that is partnered with the service provider. An additional example is a database to compile building defects for certain structures within a geographical area, such as residential homes located in a certain zip code and/or built during a certain period of time that are more prone to settlement and/or other issues. That information can then be added to an inspector's finished report to inform a potential home buyer of the potential problem. In addition, it is anticipated that the data information can also be provided to other entities, such as insurance companies, lenders, etc., to aide in the process of identifying risks and issuance of insurance policies or underwriting loans. Processing can then return to point 4A in FIG. 4A for conducting the next inspection.

The exemplary process depicted in FIGS. 4A-4C includes two critical actions in which data is transferred between the user device and the server. One of these actions is the transfer of information that was collected (i.e., during an inspection) from the user device to the server 416. The other critical action is when reports are transferred from the server to one or more recipients 438, 440, 443, 444 and 446. Because a simple drop of a single data item could be fatal to the accuracy and reliability of the data and/or report, it is imperative to have a reliable communications channel for the data transfer. Unfortunately, in embodiments in which the user device 300 interfaces to a remote server 310A over a wireless network, there is always a risk of data being lost or corrupted. This is true whether the data is transferred in multiple packets or transmissions or, as a single package. This risk is greatly increased when the amount of data transferred is large.

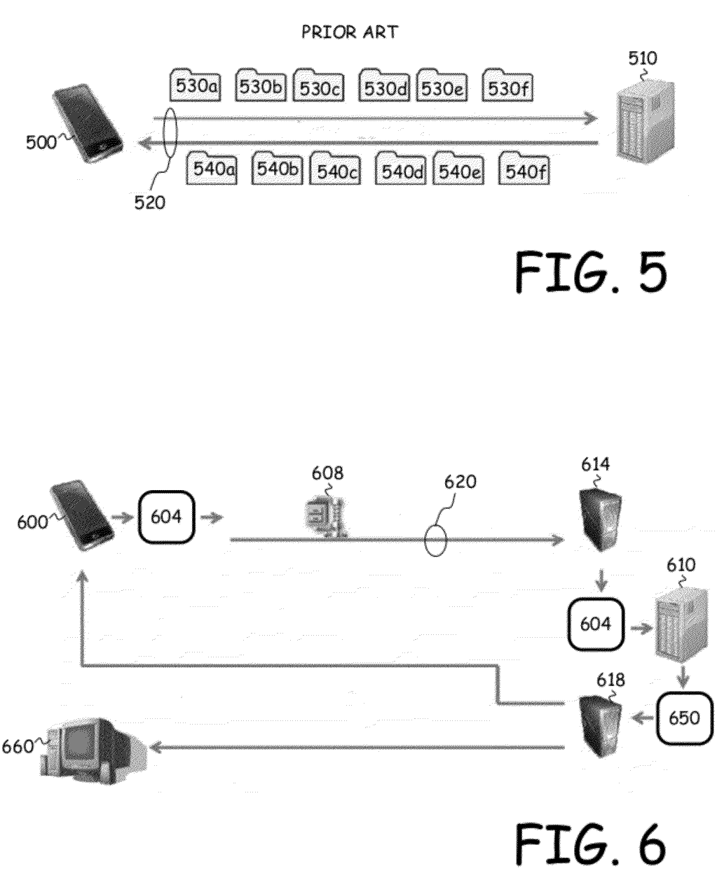

FIG. 5 is a block diagram of a technique that has been employed in the art for providing stable large data transfers from a mobile device. The illustrated technique shows the transfer of large data chunks from a mobile device 500 to a remotely located server 510 over a mobile network 520. The data chunks are typically assembled into a single file. The common technique for accomplishing data transfer between a mobile device 500 and a remotely located server 510 is by employing the use of the file transfer protocol (FTP), hypertext transfer protocol (HTTP) and variants thereof which all commonly rely upon the TCP/IP protocol for file transfer. Thus, as illustrated in FIG. 5, the transfer of files 530a-f from a mobile device 500 to a remote server 510, and files 540a-f from the remote server 510 to the mobile device 500 typically transfer these files using FTP technology. Although at the time of its creation, FTP was quite suitable to handle the data transfer demands, with today's high demand for data transfer from and to mobile devices, the use of such protocols are highly unreliable, inefficient and impose significant restrictions.

FIG. 6 is a block diagram illustrating a data transfer technique that can be employed in various embodiments of the report generator system. The illustrated solution provides for a highly reliable transfer of data between a mobile device and a server that is suitable for the various embodiments of the report generator, as well as a variety of other mobile applications. The mobile device 600 transfers data to a remote server 610 and receives data from the remote server 610. For the report generator, the data 604 being sent to the remote server 610 is in the form of a script that includes a wide range of data and information collected during an inspection process. Such data may include photographs, notes, measurements, or the like. The data 604 in some embodiments is first compressed 608. As a non-limiting example, the data 604 can be compressed into a ZIP file or by using some other technique. However, in other embodiments, the data 604 may simply be transferred as a non-compressed file. To invoke the transfer of the data 604 to the remote server 610, the data 604 is attached to an email and utilizing an email server 614, the email is transferred to the server with the data 604 over a mobile email communication path 620. In an exemplary embodiment, the mobile email path is implemented by utilizing POP3. In another embodiment, the email path is implemented using IMAP. In an exemplary embodiment, the email server has one or more email address to which the inspection data can be transferred. Then, the email server makes a determination, based on the content of the transferred data, how to process the data further. When the email message is received by the email server 614, the identity of the sending device or use is extracted and the data 604 is decompressed, or unzipped if necessary. The data 604 along with the identity of the sending device and/or user is then communicated to the server 610. The email server 614 operates to do this automatically. Thus, rather than placing the received email into a folder or inbox, the email server 614 automatically detects the reception of the email, processes it and sends the data 604 to the server 610. The server 610 can then process, analyze, assimilate and generate reports based on the received data. Likewise, the server 610 can send the data 604 or reports or files derived there from 650, to one or more devices such as mobile device 600 or computer 660. The data transfer in this direction similarly includes attaching the data 650 as a file to an email, and sending the email to the destination using mobile or standard email.

In an exemplary embodiment, the email transfer of the data can be accomplished as follows. Once the data is compressed and attached to or included in an email message, the email is sent towards the server. The email server receives the file. A script on the server recognizes the incoming file, then automatically examines the data within the email message. For instance, the email server may automatically unzip the data file and parse the data for key components or identifiers. Based on key components of the data, the server transfers the data into a designated database, then inserts additional predetermined data (based on the user recognition), then compiles all data and initiates a command to generate a PDF report. Upon generation of the PDF report, the server initiates additional commands to save the report to a predetermined database (again based on data received within the file received from the device), then initiates a final command to distribute the report via email to the predetermined recipients (again located within the initial file received from the device). Thus, the email server operating in conjunction with the server, automatically operates to receive the email message, extract the data, generate and distribute the reports.

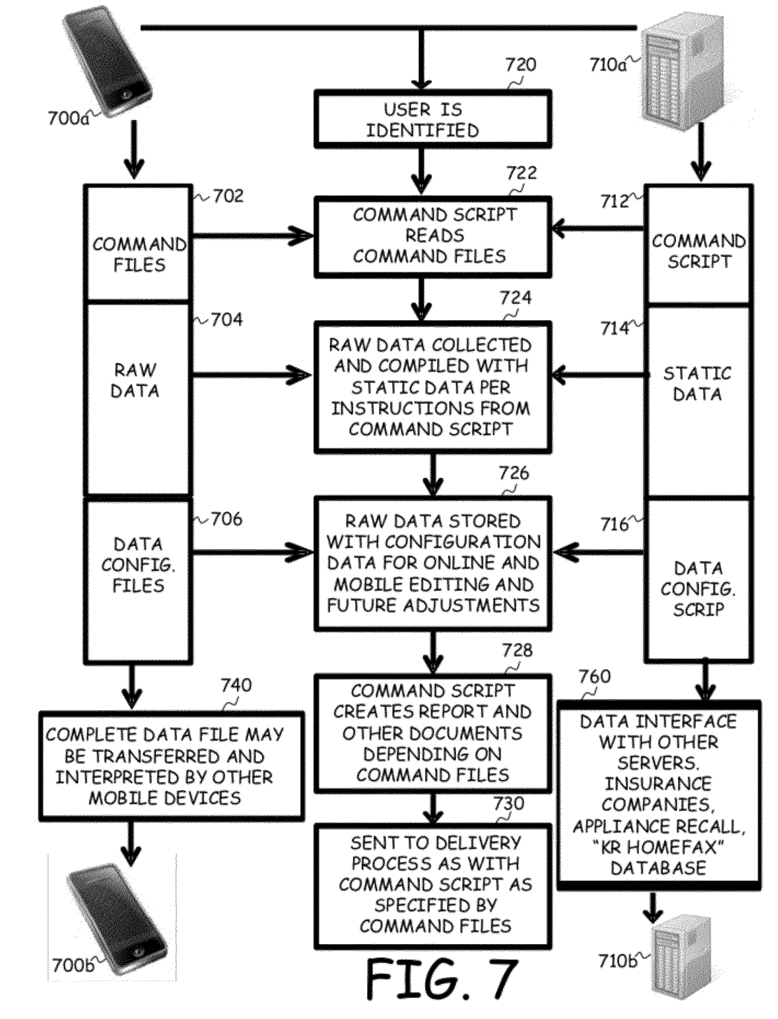

FIG. 7 is a data flow diagram illustrating the operations of one exemplary embodiment of the report generator. A user device 700a operates in conjunction with server 710a to provide the functionality of the report generator. The user device 700a includes certain command files 702 that operate to provide, among other things, a user interface for the user device 702 for presenting options, features and operations, as well as for receiving and interpreting actuations by the user. The command files 702 may also include configuration information, such as a list of email addresses to which reports are to be sent, format, content and types of reports to be generated, user identification information, or the like. In conjunction with the command files, 702, the user is able to utilize the user device 700a to input and record raw data during or following an inspection.

The server 710a includes a command script 712 that is executed upon receipt of a data upload from the user device 700a. The server 710a also may include a set of static data 714 that can include user specific data, industry specific data, company specific data, or the like.

In operation, a user of user device 700a is identified and/or authenticated with the server 710a during which process the user and/or user device 700a is identified 720. When the inspection process is completed, or at intervals during the inspection process (either automatically or by direction of the user) a data file is uploaded to the server 710a. The command script 712 reads the received command files 722 and the raw data is collected and compiled with appropriate static data 724 in accordance with instructions from the command script 712.

The server may also include a data configuration script 716 that may operate to perform one or more of at least two additional tasks. First, the data configuration script 716 may operate to generate a data file, based on the raw data 704 and data configuration files 706 received from the user device 700a. The data file can be made available for online and mobile editing and future adjustments 726. For instance, in a home inspection embodiment, upon reviewing the report, a user of the user device can edit the information that was transferred to the server and thus, update the reports. Further, the data file may be transferred and interpreted by other user devices 700b, 740. Secondly, the data configuration script 716 may actuate or exercise a data interface with other servers 710b, such as insurance companies, appliance recall, KR HOMEFAX database etc. This interaction may simply include making data available to other systems or, it may include a proactive action of notifying and or uploading the data to these other systems.

In addition, the command script 712 operates to create reports and other documents in accordance with the command files 702, 728. The reports can be based on the data/information uploaded to the server and, may or may not include static data. The reports are then submitted to a delivery process for the delivery of the reports and documents in accordance with delivery settings or requirements specified in the command files 702, 730.

The present disclosure has presented various embodiments, as well as features and aspects thereof. It should be appreciate that not all inventive embodiments require all of the features and aspects presented herein. Various embodiments may implement all of the presented features or only subsets thereof. Therefore, although selected aspects have been illustrated and described in detail, it will be understood that various substitutions and alterations may be made therein without departing from the spirit and scope of the present invention, as defined by the following claims.

What is claimed is:

1. A report generator system with reliable data transfer, comprising:
a user device;
a server that is remote to the user device and communicatively coupled to the user device or a wireless network for at least a portion of a communication path between the user device and server;
the user device configured to:
receive information to be included in a report;
compressing the information into a compressed data file;
attaching the compressed data file to an email message directed towards a specific email address;
the server, upon receipt of an email directed towards the specific email address, is configured to:
decompress the compressed data file to obtain the received information;
transforming the information into a report identified in the received information; and
transmitting the report to another destination identified in the received information by attaching the report to an email directed to the destination.

2. The report generator system of claim 1, wherein the user device is configured to compress the information by placing the information into a Zip file.

3. The report generator system of claim 1, further comprising an email server that is configured to:
receiving the email directed towards the specific email address;
provide the data file to the server and
automatically cause the server to begin to generate the report.

4. The report generator system of claim 3, wherein the server is further configured to:
determine if the user device is operating in a trial mode and if so, mark the report as a trial report, wherein the report is unfit for delivery to a client.

5. The report generator of claim 3, wherein the email server is a POP3 email server.

6. The report generator of claim 3, wherein the server is further configured to provide the report to a third party.

7. The report generator of claim 6, wherein the third party is an insurance company.

8. The report generator of claim 6, wherein the third party is a lender.

9. A method for generating inspection reports, the method comprising the actions of:
receiving inspection data into a mobile user device;
the mobile user device compressing the inspection data to create a compressed data file;
the mobile user device attaching the compressed data file to an email and transmitting the email towards the server using a specific email address and over a wireless network;
the server receiving the compressed data file and decompressing the data file to obtain the inspection data;
the server parsing the inspection data to identify what reports to generate and what recipients to which to send the reports;
the server generating one or more reports; and
the server sending the reports to the identified recipients.

10. The method of claim 9, further comprising the actions of:
a mail server receiving the email transmitted toward the server and containing the specific email address; and
automatically forwarding the compressed data file to the server.

11. The method of claim 10, wherein the server performs the actions of decompressing, parsing, generating and sending automatically upon receipt of the data file.

12. The method of claim 11, wherein the server includes a script file which is automatically activated upon receipt of the compressed data file.

13. The method of claim 9, wherein the mobile user device performs the action of compressing the inspection data by placing the inspection data into a Zip file.

14. The method of claim 13, wherein the server further performs the action of sending the report to a third party.

15. The method of claim 14, wherein the third party is selected from a group of third parties including insurance companies and lenders.

16. A mobile device utilized in a report generator system with reliable data transfer, the mobile device being configured to:
receive inspection information;
store the inspection information into an electronic file;
compress the electronic file;
attach the electronic file to an email message; and
direct the email message toward a report generating server using a specific email address.

17. The mobile device of claim 16, wherein the mobile device is configured to compress the electronic file by creating a zip file containing the inspection information.

18. The mobile device of claim 16, wherein the mobile device is configured to provide configuration data to the server including email addresses for report recipients and information regarding what types of reports to generate.

19. The mobile device of claim 16, wherein the mobile device is configured to access the server to obtain a copy of a report generated by the server based at least in part on the inspection information.

20. The mobile device of claim 19, wherein the mobile device is further configured to edit the inspection information that has been sent to the server.
